(19) United States
(12) Patent Application Publication
(10) Pub. No.: US 2014/0132650 A1
(43) Pub. Date: May 15, 2014

(54) METHOD OF DRIVING LIGHT SOURCE, LIGHT SOURCE APPARATUS FOR PERFORMING THE METHOD AND DISPLAY APPARATUS HAVING THE LIGHT SOURCE APPARATUS

(71) Applicant: SAMSUNG DISPLAY CO. LTD., Yongin-City (KR)

(72) Inventors: Ho-Sik SHIN, Gunpo-si (KR); Yong-Hoon KWON, Suwon-si (KR); Jung-Hyun YANG, Seoul (KR)

(73) Assignee: Samsung Display Co., LTD., Yongin-City (KR)

(21) Appl. No.: 13/834,631

(22) Filed: Mar. 15, 2013

(30) Foreign Application Priority Data
Nov. 12, 2012 (KR) 10-2012-0127093

(51) Int. Cl. G09G 5/10

(52) U.S. Cl. CPC G09G 5/10
USPC 345/694

(57) ABSTRACT

A method of driving a light source includes: determining a ratio of a first display area with respect to an entire display area by analyzing an image data, where the first display area displays a maximum luminance image; generating a duty ratio control signal which controls a duty ratio of a driving signal based on the ratio of the first display area, where the driving signal drives a light source in a first light emitting area of a light source module, and the first light emitting area corresponds to the first display area; and outputting the driving signal to the light source module based on the duty ratio control signal.

This application claims priority to Korean Patent Application No. 10-2012-0127093, filed on Nov. 12, 2012, and all the benefits accruing therefrom under 35 U.S.C. §119, the content of which in its entirety is herein incorporated by reference.

### BACKGROUND

1. Field

Exemplary embodiments of the invention relate to a method of driving a light source, a light source apparatus for performing the method and display apparatus having the light source apparatus. More particularly, exemplary embodiments of the invention relate to a method of driving a light source used in a display apparatus, a light source apparatus for performing the method and display apparatus having the light source apparatus.

2. Description of the Related Art

Recently, a three-dimensional stereoscopic image is displayed using a display apparatus such as a liquid crystal display apparatus according to a demand of the three-dimensional stereoscopic image in fields such as games, movies and so on.

A display panel in the display apparatus may alternately display a left-eye image and a right-eye image every frame to display the three-dimensional image.

However, an image data of a previous frame may overlap an image data of a frame in an initial period of the frame. That is, a three-dimensional stereoscopic image crosstalk may occur, and thus a display quality of the display apparatus may be degraded.

In addition, recently a local dimming driving method for controlling light sources in a light source module based on an image data displayed on the display panel for increasing a contrast ratio (“CR”) of an image has been developed.

In the local dimming method, the light source module is typically disposed on a rear surface of the display panel, and the light source module includes a plurality of light sources disposed substantially in a matrix form. In the local dimming method, a number of the light sources in the light source module may be increased such that power consumption of the display apparatus may increase.

### SUMMARY

Exemplary embodiments of the invention provide a method of driving a light source, in which display quality of a display apparatus is substantially improved and power consumption of the display apparatus is substantially decreased.

Exemplary embodiments of the invention also provide a light source apparatus for performing the method of driving a light source.

Exemplary embodiments of the invention also provide a display apparatus having the light source apparatus.

According to an exemplary embodiment of the invention, a method of driving a light source includes: determining a ratio of a first display area with respect to an entire display area by analyzing an image data, where the first display area displays a maximum luminance image; generating a duty ratio control signal which controls a duty ratio of a driving signal based on the ratio of the first display area, where the driving signal drives a light source in a first light emitting area of a light source module, and the first light emitting area corresponds to the first display area; and outputting the driving signal to the light source module based on the duty ratio control signal.

In one exemplary embodiment, the duty ratio of the driving signal may be increased as the ratio of the first display area decreases, and the duty ratio of the driving signal may be decreased as the ratio of the first display area increases.

In one exemplary embodiment, the duty ratio of the driving signal which drives the light source in the first light emitting area may be a first ratio.

In one exemplary embodiment, the first ratio may be equal to or less than about 50%.

In one exemplary embodiment, the driving signal which drives the light source in the first light emitting area may be inactivated during an initial period of a frame, and the light source in the first light emitting area may be turned off during the initial period of the frame based on the driving signal.

In one exemplary embodiment, the determining the ratio of the first display area may include: determining whether the ratio of the first display area is about 100% or not; determining whether the ratio of the first display area is less than 100% and equal to or greater than a first value, which is less than about 100%, or not; and determining whether the ratio of the first display area is less than the first value or not.

In one exemplary embodiment, the duty ratio of the driving signal may be less than about 50%, when the ratio of the first display area is equal to or greater than the first value.

In one exemplary embodiment, the duty ratio of the driving signal may be about 50%, when the ratio of the first display area is less than the first value.

In one exemplary embodiment, the determining the ratio of the first display area may include: determining whether the ratio of the first display area is less than a second value, which is less than the first value or not; and determining whether the ratio of the first display area is less than the first value and equal to or greater than the second value or not.

In one exemplary embodiment, the method may further include: outputting a current control signal which maintains a current of the driving signal when the ratio of the first display area is equal to or greater than the second value; and outputting the current control signal which increases the current of the driving signal when the ratio of the first display area is less than the second value.

In one exemplary embodiment, the method may further include analyzing the image data to determine a second display area which displays a minimum luminance image.

In one exemplary embodiment, a duty ratio of a driving signal which drives a light source in a second light emitting area may be about zero (0), where the second light emitting area corresponds to the second display area.

According to another exemplary embodiment of the invention, a light source apparatus includes a light source module including a plurality of light sources; and a light source driving part configured to determine a ratio of a first display area with respect to an entire display area by analyzing an image data, configured to generate a duty ratio control signal, which controls a duty ratio of a driving signal based on the ratio of the first display area, and configured to output the driving signal, which drives a light source of the light sources corresponding to the first display area, to the light source module, where the first display area displays a maximum luminance image.

In one exemplary embodiment, the duty ratio of the driving signal may be increased as the ratio of the first display area decreases, and the duty ratio of the driving signal may be decreased as the ratio of the first display area increases.

In one exemplary embodiment, the light source driving part may include an image analyzing part configured to analyze the image data to determine the ratio of the first display area, a duty ratio controlling part configured to generate the duty ratio control signal of the driving signal based on the ratio of the first display area, and a driving signal generating part configured to output the driving signal to the light source module based on the duty ratio control signal.

In one exemplary embodiment, the image analyzing part may determine whether the ratio of the first display area is about 100% or not, the image analyzing part may determine whether the ratio of the first display area is less than about 100% and equal to or greater than a first value, which is less than about 100%, or not, and the image analyzing part may determine whether the ratio of the first display area is less than the first value or not.

In one exemplary embodiment, the duty ratio of the driving signal may be less than about 50%, when the ratio of the first display area is equal to or greater than the first value, and the duty ratio of the driving signal may be about 50%, when the ratio of the first display area is less than the first value.

In one exemplary embodiment, the image analyzing part may determine whether the ratio of the first display area is less than a second value, which is less than the first value, or not, and the image analyzing part may determine whether the ratio of the first display area is less than the first value and equal to or greater than the second value or not.

In one exemplary embodiment, the light source driving part may further include a current controlling part configured to maintain a current of the driving signal when the ratio of the first display area is equal to or greater than the second value and configured to increase the current of the driving signal when the ratio of the first display area is less than the second value.

According to still another exemplary embodiment of the invention, a display apparatus includes: a display panel displaying an image corresponding to an image data; a light source module disposed facing an edge portion of the display panel, where the light source provides light to the display panel and includes a plurality of light sources; and a light source driving part configured to determine a ratio of a first display area with respect to an entire display area by analyzing the image data, configured to generate a duty ratio control signal controls a duty ratio of a driving signal based on the ratio of the first display area, and configured to output the driving signal to the light source module based on the duty ratio control signal, where the first display area displays a maximum luminance image, where the duty ratio control signal increases the duty ratio of the driving signal as the ratio of the first display areas decreases and decreases the duty ratio of the driving signal as the ratio of the first display area increases, and where the driving signal drives a light source in a first light emitting area of the light source module corresponding to the first display area.

According to exemplary embodiments of the invention, crosstalk of a three-dimensional stereoscopic image is effectively prevented, and thus display quality of the display apparatus is substantially improved.

In such embodiments, a current of a driving signal may be controlled based on a ratio of a first display area, which displays a maximum luminance image, and a ratio of a second display area, which displays a minimum luminance image, and thus power consumption of the display apparatus is substantially decreased.

### BRIEF DESCRIPTION OF THE DRAWINGS

The above and other features of the invention will become more apparent by describing in detailed exemplary embodiments thereof with reference to the accompanying drawings, in which:

FIG. 1 is a block diagram illustrating an exemplary embodiment of a display apparatus according to the invention;

FIG. 2A is a block diagram illustrating a display panel and a light source module of FIG. 1;

FIG. 2B is a waveform diagram illustrating an exemplary embodiment of a driving signal applied to the light source module of FIG. 1;

FIG. 3A a block diagram illustrating an alternative exemplary embodiment of a display panel and a light source module;

FIGS. 3B to 3D are waveform diagrams illustrating alternative exemplary embodiments of driving signals applied to the light source module of FIG. 1;

FIG. 4 is a flow chart illustrating an exemplary embodiment of a method of driving a light source driving part in FIG. 1;

FIG. 5 is a block diagram illustrating an alternative exemplary embodiment of a display apparatus according to the invention;

FIG. 6A is a block diagram illustrating an exemplary embodiment of a display panel and a light source module;

FIGS. 6B to 6D are waveform diagrams illustrating exemplary embodiments of driving signals applied to a light source module of FIG. 5;

FIG. 7 is a flow chart illustrating an exemplary embodiment of a method of driving a light source driving part in FIG. 5;

FIG. 8 is a graph illustrating power consumption (IEC) of a normal driving display apparatus, a local dimming driving display apparatus and an exemplary embodiment of the display apparatus;

FIG. 9 is a graph illustrating power consumption (Watt: W) according to a ratio (%) of a first display area of the normal driving display apparatus, the local dimming driving display apparatus and an exemplary embodiment of the display apparatus;

FIG. 10 is a graph illustrating halation power consumption (W) according to the ratio (%) of the first display area of the normal driving display apparatus, the local dimming driving display apparatus and an exemplary embodiment of the display apparatus;

FIG. 11 is a graph illustrating a luminance (candela per square meter: cd/m²) according to the ratio (%) of the first display area (%) of the normal driving display apparatus, the local dimming driving display apparatus and an exemplary embodiment of the display apparatus;

FIG. 12 is a graph illustrating a halation luminance (cd/m²) according to the ratio (%) of the first display area of the normal driving display apparatus, the local dimming driving display apparatus and an exemplary embodiment of the display apparatus;

FIG. 13 is a graph illustrating a luminance (cd/m²) influencing an adjacent display block in accordance with a distance (millimeter: mm) between display blocks of the local dimming driving display apparatus and an exemplary embodiment of the display apparatus;

FIG. 14 is a graph illustrating a relation between a solid angle (radian) and a dazzle peak luminance (cd/m²) according to illuminance (lux);

FIG. 15 is a graph illustrating a relation between the solid angle (radian) and a dazzle peak luminance (cd/m²) according to an average picture level (“APL”);

FIG. 16 is a graph illustrating a cone photoreceptors distribution of an eye;

FIG. 17 is a graph illustrating a dazzle peak luminance (cd/m²) according to a grayscale value (IRE) and the ratio (%) of the first display area; and

FIG. 18 is a graph illustrating a luminance ratio according to a grayscale value (IRE) and a ratio (%) of the first display area of cathode ray tube (“CRT”) display apparatus, the normal driving display apparatus and an exemplary embodiment of the display apparatus.

### DETAILED DESCRIPTION

The invention will be described more fully hereinafter with reference to the accompanying drawings, in which exemplary embodiments of the invention are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiments of the invention will be described in detail with reference to the accompanying drawings.

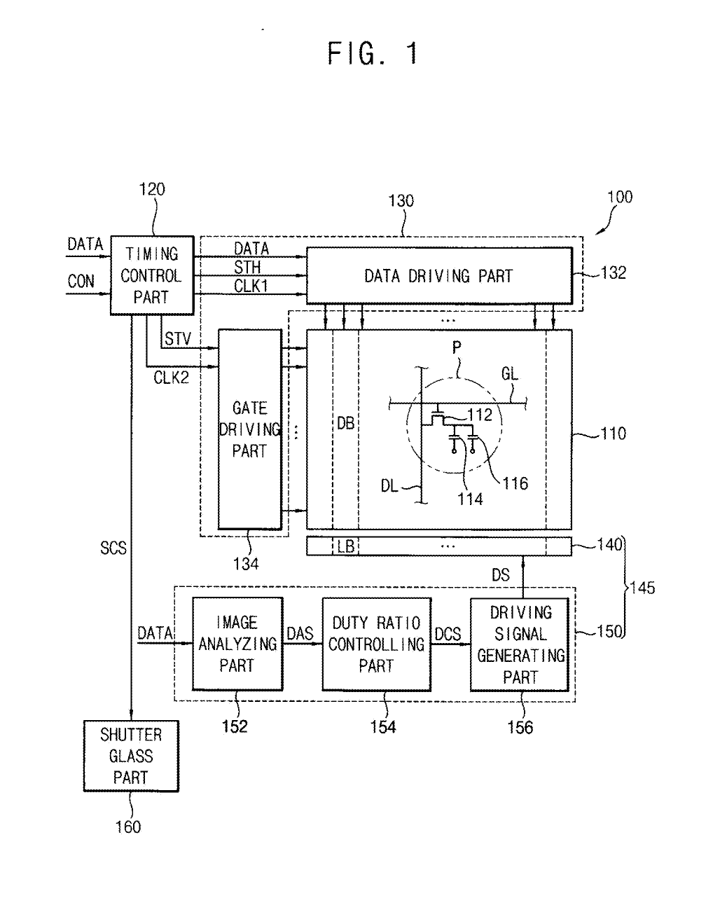

FIG. 1 is a block diagram illustrating an exemplary embodiment of a display apparatus according to the invention.

Referring to FIG. 1, an exemplary embodiment of the display apparatus 100 includes a display panel 110, a timing control part 120, a driving part 130, a light source apparatus 145 and a shutter glass part 160. The light source apparatus 145 includes a light source module 140 and a light source driving part 150.

The display panel 110 receives an image data DATA to display an image. The display panel 110 includes a plurality of gate lines GL, a plurality of data lines DL and a plurality of pixels P. In one exemplary embodiment, for example, the display panel 110 includes M×N (each of M and N is a natural number) pixels P. Each of the pixels P includes a thin-film transistor 112 electrically connected to a corresponding gate line of the gate lines and a corresponding data line of the data lines, a liquid crystal capacitor 114 and a storage capacitor 116 connected to the thin-film transistor 112. The display panel 110 includes a plurality of display blocks DB.

The timing control part 120 receives the image data DATA and a control signal CON from an outside. The control signal CON may include a horizontal synchronous signal, a vertical synchronous signal and a clock signal.

The timing control part 120 generates a horizontal start signal STH based on the horizontal synchronous signal and outputs the horizontal start signal STH to a data driving part 132. The timing control part 120 generates a vertical start signal STV based on the vertical synchronous signal and outputs the vertical start signal STV to a gate driving part 134. The timing control part 120 generates a first clock signal CLK1 and a second clock signal CLK2 based on the clock signal and outputs the first clock signal CLK1 to the data driving part 132 and the second clock signal CLK2 to the gate driving part 134.

The timing control part 120 may output a shutter glass control signal SCS that controls the shutter glass part 160.

The driving part 130 includes the data driving part 132 and the gate driving part 134.

The data driving part 132 outputs a data signal based on the image data DATA to the data lines DL in response to the first clock signal CLK1 and the horizontal start signal STH provided from the timing control part 120.

The gate driving part 134 generates a gate signal using the vertical start signal STV and the second clock signal CLK2 provided from the timing control part 120 and outputs the gate signal to the gate lines GL.

The light source module 140 includes a plurality of light emitting blocks LB, and the light emitting blocks LB correspond to the display blocks DB. Each of the light emitting blocks LB includes a light source that provides light to the display panel 110. In one exemplary embodiment, for example, the light source may be a light emitting diode (“LED”). The light source module 140 is disposed facing an edge portion of the display panel 110. In one exemplary embodiment, for example, the display panel 110 may have a rectangular shape, and the light source module 140 may face a longer side of the display panel 110. Thus, the display blocks DB corresponding to the light emitting blocks LB may have a linear shape substantially parallel to the data lines DL.

The light source driving part 150 includes an image analyzing part 152, a duty ratio controlling part 154 and a driving signal generating part 156.

The image analyzing part 152 receives the image data DATA, analyzes the image data DATA and outputs an image data analyzing signal DAS. In one exemplary embodiment, for example, the image analyzing part 152 analyzes the image data DATA to determine a ratio of a first display area with respect to an entire display area in the display panel 110. In such an embodiment, the first display area displays a maximum luminance image.

In one exemplary embodiment, for example, the image analyzing part 152 may determine whether the image data DATA is a full white or not. Thus, the image analyzing part 152 may determine whether the ratio of the first display area is about 100% or not. In such an embodiment, the image analyzing part 152 may determine whether the ratio of the first display area which displays the maximum luminance image of the image data DATA is less than a first value, which is less than about 100%, or not. In one exemplary embodiment, for example, the first value may be about 50%. In an exemplary embodiment, the image analyzing part 152 may determine whether the ratio of the first display area is less than about 100% and equal to or greater than the first value or not. Thus, the image data analyzing signal DAS indicates the ratio of the first display area which displays the maximum luminance image of the image data DATA.

In an exemplary embodiment, the image analyzing part 152 may further determine a second display area which displays a minimum luminance image. In such an embodiment, the image analyzing part 152 may further determine a third display area having a luminance between a maximum luminance of the first display area and a minimum luminance of the second display area.

The duty ratio controlling part 154 receives the image data analyzing signal DAS outputted from the image analyzing part 152 and generates a duty ratio control signal DCS based on the image data analyzing signal DAS. The duty ratio control signal DCS increases a duty ratio of a driving signal DS for driving a light source in a first light emitting area corresponding to the first display area as the ratio of the first display area is low, and the duty ratio control signal DCS decreases the duty ratio of the driving signal DS for driving the light source in the first light emitting area corresponding to the first display area as the ratio of the first display area is high.

In one exemplary embodiment, for example, the duty ratio controlling part 154 may output the duty ratio control signal DCS that controls the duty ratio of the driving signal DS as a duty ratio of about 30% when the ratio of the first display area is equal to or greater than the first value, and output the duty ratio control signal DCS controlling the duty ratio of the driving signal as a duty ratio of about 50% when the ratio of the first display area is less than the first value.

In an exemplary embodiment, the duty ratio controlling part 154 may control a maximum duty ratio of the driving signal DS. In one exemplary embodiment, for example, the maximum duty ratio of the driving signal DS may be about 50%.

The driving signal generating part 156 receives the duty ratio control signal DCS outputted from the duty ratio controlling part 154 and outputs the driving signal DS to the light source module 140, based on the duty ratio control signal DCS.

The image data DATA may include a left-eye image data and a right-eye image data, and the display panel 110 may alternately display the left-eye image data and the right-eye image data every frame. Thus, the display panel may display a three-dimensional stereoscopic image.

The shutter glass part 160 includes a left-eye portion and a right-eye portion, and the shutter glass 160 selectively opens and closes the left-eye portion and the right-eye portion based on the shutter glass control signal SCS. In one exemplary embodiment, for example, the shutter glass part 160 may open the left-eye portion and close the right-eye portion when the left-eye image data is displayed on the display panel 110. In such an embodiment, the shutter glass part 160 may close the left-eye portion and open the right-eye portion when the right-eye image data is displayed on the display panel 110.

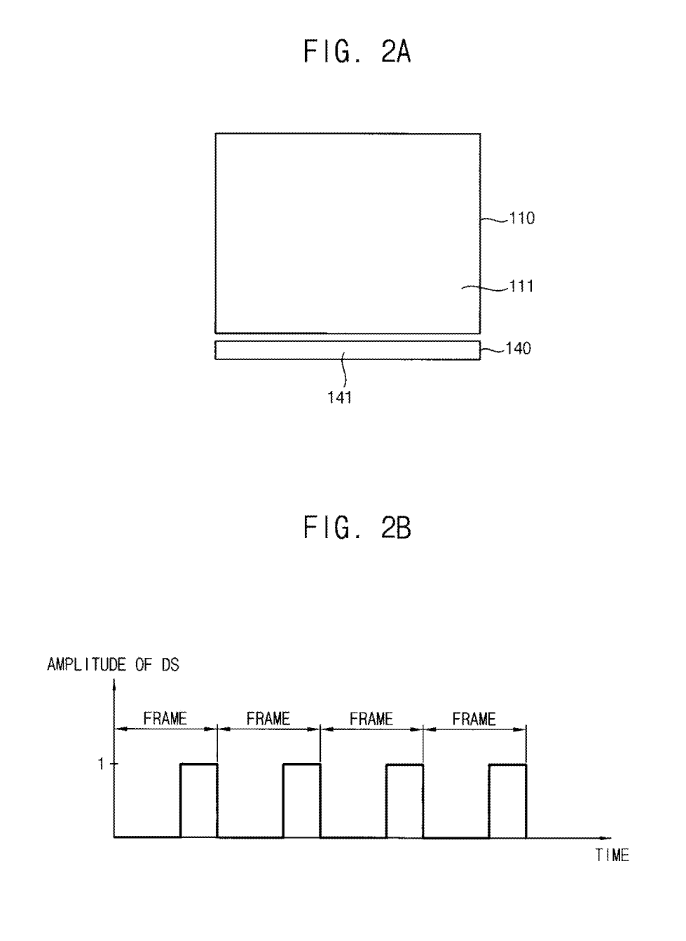

FIG. 2A is a block diagram illustrating an exemplary embodiment of the display panel 110 and the light source module 140 of FIG. 1, and FIG. 2B is a waveform diagram illustrating an exemplary embodiment of the driving signal DS applied to the light source module 140 of FIG. 1.

Referring to FIGS. 1 and 2A, when the image data DATA is the full white, a ratio of a first display area 111, which displays a maximum luminance image in the display panel 110, is about 100%. The light source module 140 includes a first light emitting area 141 corresponding to the first display area 111.

Referring to FIGS. 1, 2A and 2B, the duty ratio controlling part 154 of the light source driving part 150 may control the duty ratio of the driving signal DS for driving a light source in the first light emitting area 141 of the light source module 140 as a first duty ratio. In an exemplary embodiment, the duty ratio of the driving signal DS is less than about 50%. In one exemplary embodiment for example, the duty ratio of the driving signal DS may be about 30%. In such an embodiment, the driving signal DS is inactivated during an initial period of the frame, and thus the light source in the first light emitting area 141 may be turned off during the initial period of the frame.

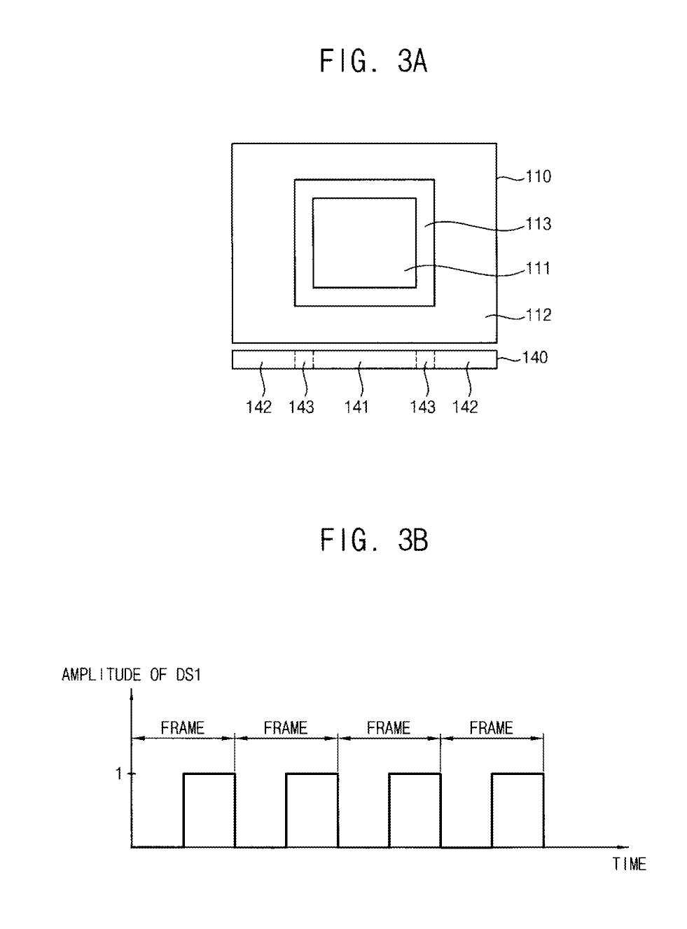

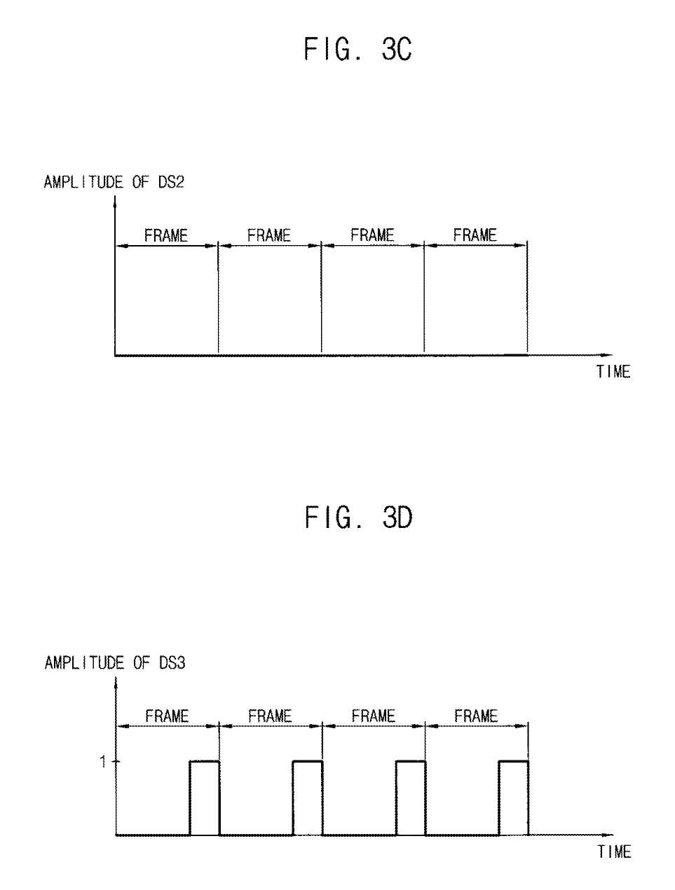

FIG. 3A is a block diagram illustrating an alternative exemplary embodiment of the display panel 110 and the light source module 140, and FIGS. 3B to 3D are waveform diagrams illustrating alternative exemplary embodiments of driving signals applied to the light source module 140 of FIG. 1.

Referring to FIGS. 1 and 3A, the ratio of the first display area 111 which displays the maximum luminance image of the image data DATA may be less than the first value. In one exemplary embodiment, for example, the first value may be about 50%, and the ratio of the first display area 111 may be about 40%.

In an exemplary embodiment, the display panel 110 may further include a second display area 112 which displays a minimum luminance image. In such an embodiment, the display panel 110 may further include a third display area 113 having a luminance between a maximum luminance of the first display area 111 and a minimum luminance of the second display area 112.

The light source module 140 includes a first light emitting area 141 corresponding to the first display area 111, a second light emitting area 142 corresponding to the second display area 112, and a third light emitting area 143 corresponding to the third display area 113.

Referring to FIGS. 1, 3A and 3B, the duty ratio controlling part 154 of the light source driving part 150 may control a duty ratio of a first driving signal DS1 for driving a light source in the first light emitting area 141 of the light source module 140 as a second duty ratio. In one exemplary embodiment, for example, the duty ratio of the first driving signal DS1 may be about 50%. In such an embodiment, the first driving signal DS1 is inactivated during the initial period of the frame, and thus the light source in the first light emitting area 141 may be turned off during the initial period of the frame. In an exemplary embodiment, amplitude of the first driving signal DS1 may be about 1, for example.

In one exemplary embodiment, for example, the left-eye image data may be displayed on the display panel 110 during a first frame period, the right-eye image data may be displayed on the display panel 110 during a second frame period, the left-eye image data may be displayed on the display panel 110 during a third frame period, and the right-eye image data may be displayed on the display panel 110 during a fourth frame period. In such an embodiment, the light source in the first light emitting area 141 may be turned off during each of initial periods of the first, second, third and fourth frames. In such an embodiment, an overlapping of the left-eye image data and the right-eye image data is effectively prevented, and thus a crosstalk of the three-dimensional stereoscopic image is effectively prevented.

Referring to FIGS. 1, 3A and 3C, the duty ratio controlling part 154 of the light source driving part 150 may control a duty ratio of a second driving signal DS2 for driving a light source in the second light emitting area 142 of the light source module 140 as a duty ratio of about zero (0) %.

Referring to FIGS. 1, 3A and 3D, the duty ratio controlling part 154 of the light source driving part 150 may control a duty ratio of a third driving signal DS3 for driving a light source in the third light emitting area 143 of the light source module 140 as about a third duty ratio. In an exemplary embodiment, the duty ratio of the third driving signal DS3 is in a range of about zero (0) % to about 50%. In one exemplary embodiment, for example, and the duty ratio of the third driving signal DS3 may be about 20%.

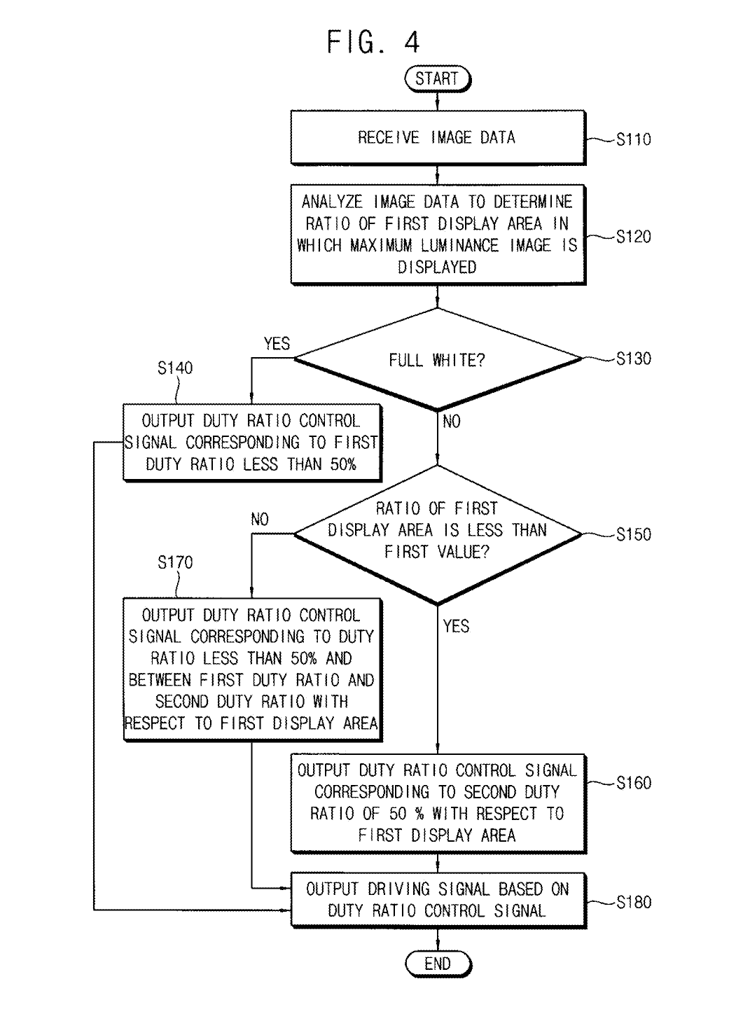

FIG. 4 is a flow chart illustrating an exemplary embodiment of a method of driving the light source driving part 150 in FIG. 1.

Referring to FIGS. 1 and 4, the image analyzing part 152 receives the image data DATA (S110). The image data DATA may include the left-eye image data and the right-eye image data to display the three-dimensional stereoscopic image on the display panel 110.

In an exemplary embodiment, the image analyzing part 152 analyzes the image data DATA to determine the ratio of the first display area with respect to the entire display area of the display panel 110 (S120). In such an embodiment, the first display area displays the maximum luminance image.

In an exemplary embodiment, the image analyzing part 152 determines whether the image data DATA is the full white or not (S130). Thus, the image analyzing part 152 determines whether the ratio of the first display area is about 100% or not.

When the image data DATA is the full white, the duty ratio controlling part 154 outputs the duty ratio control signal DCS that controls the duty ratio of the driving signal DS for driving the light source in the first light emitting area of the light source module 140 corresponding to the first display area as the first duty ratio less than about 50% (S140).

The driving signal generating part 156 outputs the driving signal DS to the light source module 140 based on the duty ratio control signal DCS (S180).

When the image data is not the full white, the image analyzing part 152 determines whether the ratio of the display area is less than the first value or not (S150). In one exemplary embodiment, for example, the first value may be about 50%.

When the ratio of the first display area is less than the first value, the duty ratio controlling part 154 outputs the duty ratio control signal DCS that controls the duty ratio of the driving signal DS as the second duty ratio of about 50% (S160).

The driving signal generating part 156 outputs the driving signal DS to the light source module 140 based on the duty ratio control signal DCS (S180).

When the ratio of the first display area is not less than the first value, the duty ratio controlling part 154 outputs the duty ratio control signal DCS that controls the duty ratio of the driving signal DS as a duty ratio less than about 50% and between the first duty ratio and the second duty ratio (S170).

The driving signal generating part 156 outputs the driving signal DS to the light source module 140 based on the duty ratio control signal DCS (S180).

In an exemplary embodiment, the light source part 150 controls the duty ratio of the driving signal DS for driving the light source module 140 as a duty ratio less than about 50%, and deactivates the driving signal during the initial period of the frame, and thus, the crosstalk of the three-dimensional stereoscopic image is effectively prevented.

In an exemplary embodiment, the light source module 140 is disposed facing the edge portion of the display panel 110, and a number of the light source in the light source module 140 is thereby decreased. Thus, in such an embodiment, a power consumption of the display apparatus 100 is substantially decreased.

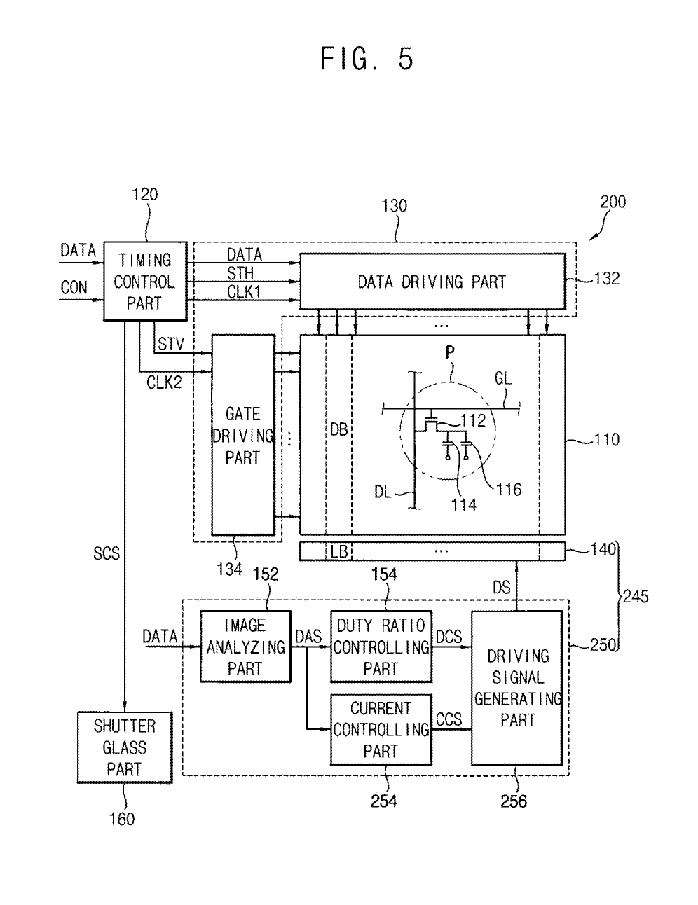

FIG. 5 is a block diagram illustrating an alternative exemplary embodiment of a display apparatus according to the invention.

The display apparatus 200 shown in FIG. 5 is substantially the same as the display apparatus 100 illustrated in FIG. 1 except for a light source apparatus 245 and a light source driving part 250. The same or like elements shown in FIG. 5 have been labeled with the same reference characters as used above to describe the exemplary embodiments of the display apparatus shown in FIG. 1, and any repetitive detailed description thereof will hereinafter be omitted or simplified.

Referring to FIG. 5, an alternative exemplary embodiment of the display apparatus 200 includes the display panel 110, the timing control part 120, the driving part 130, the light source apparatus 245 and the shutter glass part 160. The light source apparatus 245 includes the light source module 140 and the light source driving part 250.

The light source driving part 250 includes the image analyzing part 152, the duty ratio controlling part 154, a current controlling part 254 and a driving signal generating part 256.

The image analyzing part 152 receives the image data DATA, and analyzes the image data DATA to output the image data analyzing signal DAS. In an exemplary embodiment, the image analyzing part 152 analyzes the image data DATA to determine the ratio of the first display area with respect to an entire display area in the display panel 110. In such an embodiment, the first display area displays a maximum luminance image.

In one exemplary embodiment, for example, the image analyzing part 152 may determine whether the image data DATA is a full white or not. Thus, the image analyzing part 152 may determine whether the ratio of the first display area is about 100% or not. In an exemplary embodiment, the image analyzing part 152 may determine whether the ratio of the first display area which displays the maximum luminance image of the image data DATA is less than a first value, which is less than about 100%, or not. In such an embodiment, the image analyzing part 152 may determine whether the ratio of the first display area is less than a second value, which is less than the first value, or not. In such an embodiment, the image analyzing part 152 may determine whether the ratio of the first display area is less than the first value and equal to or greater than the second value or not. In one exemplary embodiment, for example, the first value may be about 50%, and the second value may be about 30%. Thus, the image data analyzing signal DAS indicates the ratio of the first display area which displays the maximum luminance image of the image data DATA.

The duty ratio controlling part 154 receives the image data analyzing signal DAS outputted from the image analyzing part 152 and generates a duty ratio control signal DCS. The duty ratio control signal DCS increases a duty ratio of a driving signal DS for driving a light source in a first light emitting area corresponding to the first display area, as the ratio of the first display area decreases, and the duty ratio control signal DCS decreases the duty ratio of the driving signal DS driving the light source in the first light emitting area corresponding to the first display area, as the ratio of the first display area increases.

In one exemplary embodiment, for example, the duty ratio controlling part 154 may output the duty ratio control signal DCS corresponding to a duty ratio of about 30%, e.g., the duty ratio control signal DCS that controls the duty ratio of the driving signal DS as the duty ratio of about 30%, when the ratio of the first display area is equal to or greater than the first value, and output the duty ratio control signal DCS corresponding to a duty ratio of about 50%, e.g., the duty ratio control signal DCS that controls the duty ratio of the driving signal as the duty ratio of about 50% when the ratio of the first display area is less than the first value.

The current controlling part 254 receives the image data analyzing signal DAS outputted from the image analyzing part 152 and outputs a current control signal CCS. In such an embodiment, the current control signal CCS maintains a current of the driving signal DS when the ratio of the first display area is equal to or greater than the second value, and increases the current of the driving signal DS when the ratio of the first display area is less than the second value.

The driving signal generating part 256 receives the duty ratio control signal DCS outputted from the duty ratio controlling part 154 and the current control signal CCS outputted from the current controlling part 254, and outputs the driving signal DS to the light source module 140, based on the duty ratio control signal DCS and the current control signal CCS.

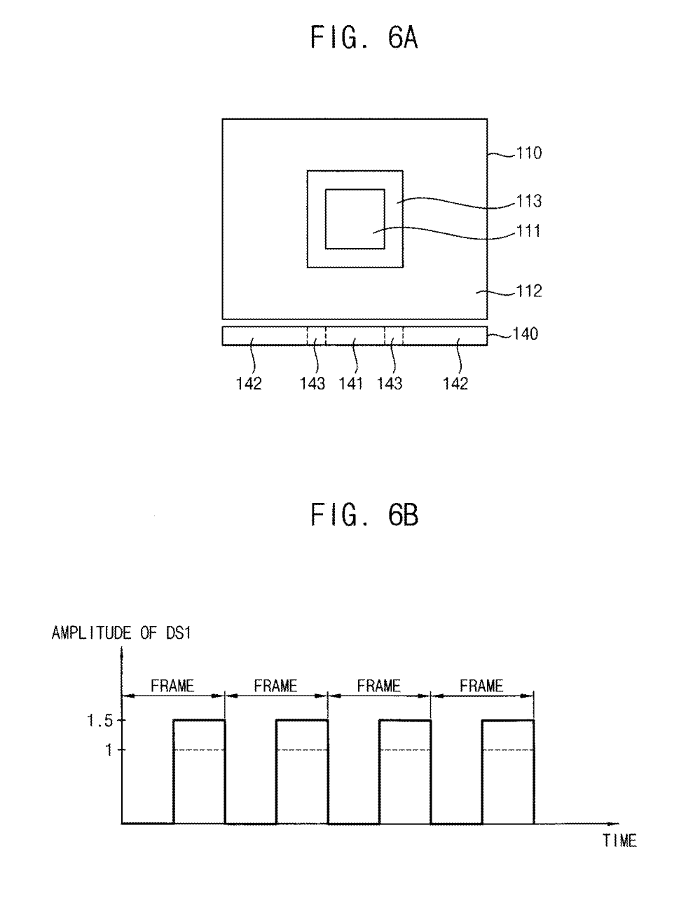

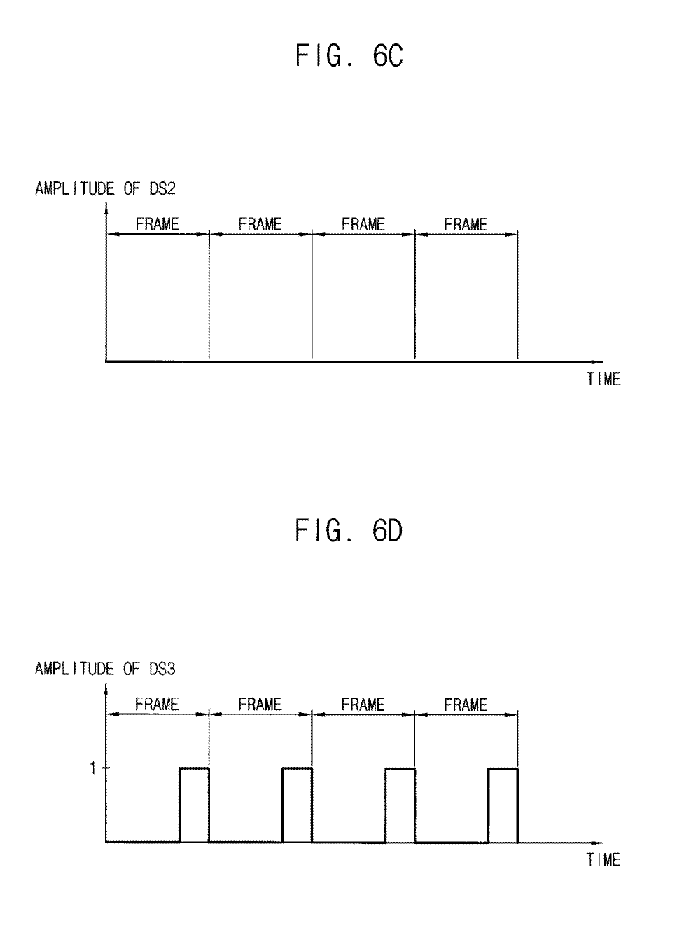

FIG. 6A is a block diagram illustrating an exemplary embodiment of the display panel 110 and the light source module 140, and FIGS. 6B to 6D are waveform diagrams illustrating exemplary embodiments of driving signals applied to the light source module 140 of FIG. 5.

Referring to FIGS. 5 and 6A, a ratio of a first display area 111 which displays a maximum luminance image of the image data DATA may be less than a second value. In one exemplary embodiment, for example, the second value may be about 30%, and the ratio of the first display area 111 may be about 20%.

In an exemplary embodiment, the display panel 110 may further include a second display area 112 which displays a minimum luminance image. In such an embodiment, the display panel 110 may further include a third display area 113 having a luminance between a maximum luminance of the first display area 111 and a minimum luminance of the second display area 112.

The light source module 140 includes a first light emitting area 141 corresponding to the first display area 111, a second light emitting area 142 corresponding to the second display area 112, and a third light emitting area 143 corresponding to the third display area 113.

Referring to FIGS. 5, 6A and 6B, the duty ratio controlling part 154 of the light source driving part 250 may control a duty ratio of a first driving signal DS1 for driving a light source in the first light emitting area 141 of the light source module 140 as a second duty ratio. In one exemplary embodiment, for example, the duty ratio of the first driving signal DS1 may be about 50%. In such an embodiment, the first driving signal DS1 is inactivated during the initial period of the frame, and thus the light source in the first light emitting area 141 may be turned off during the initial period of the frame.

In an exemplary embodiment, the current controlling part 254 of the light source driving part 250 may increase a current of the first driving signal DS1. In one exemplary embodiment, for example, amplitude of the first driving signal DS1 may be about 1.5. Thus, the amplitude of the first driving signal DS1 may be about 1 when the ratio of the first display area 111 is between the first value and the second value, and the amplitude of the first driving signal DS1 may be greater than about 1 when the ratio of the first display area 111 is less than the second value less than the first value.

Referring to FIGS. 5, 6A and 6C, the duty ratio controlling part 154 of the light source part 250 may control a duty ratio of a second driving signal DS2 for driving a light source in the second light emitting area 142 of the light source module 140 as a duty ratio of about zero (0) %.

Referring to FIGS. 5, 6A and 6D, the duty ratio controlling part 154 of the light source driving part 250 may control a duty ratio of a third driving signal DS3 for driving a light source in the third light emitting area 143 of the light source module 140 as about a third duty ratio. In an exemplary embodiment, the duty ratio of the third driving signal DS3 is in a range of about zero (0) % to about 50%. In one exemplary embodiment, for example, the duty ratio of the third driving signal DS3 may be about 20%.

In such an embodiment, the ratios of the second display area 112 and the third display area 113 are increased as the ratio of the first display area 111 is decreased.

Thus, in such an embodiment, the current of the second driving signal DS2 for driving the light source in the second light emitting area 142 corresponding to the second display area 112 and the current of the third driving signal DS3 for driving the light source in the third light emitting area 143 corresponding to the third display area 113 may be decreased.

Thus, in such an embodiment, the light source driving part 250 may increase the current of the first driving signal DS1 for driving the light source in the first light emitting area 141 corresponding to the first display area 111 without increasing power consumption.

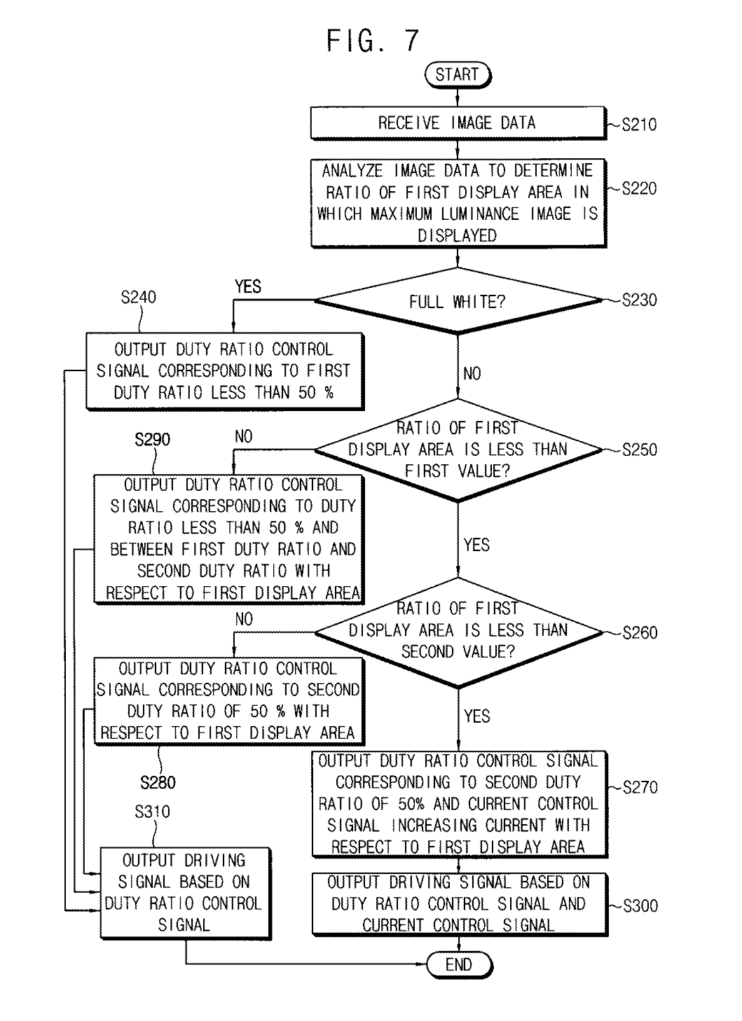

FIG. 7 is a flow chart illustrating an exemplary embodiment of a method of driving the light source driving part 250 in FIG. 5.

Referring to FIGS. 5 and 7, the image analyzing part 152 receives the image data DATA (S210). The image data DATA may include the left-eye image data and the right-eye image data to display the three-dimensional stereoscopic image on the display panel 110.

The image analyzing part 152 analyzes the image data DATA to determine the ratio of the first display area with respect to the entire display area of the display panel 110 (S220). The first display area displays the maximum luminance image.

The image analyzing part 152 determines whether the image data DATA is the full white or not (S230). In such an embodiment, the image analyzing part 152 determines whether the ratio of the first display area is about 100% or not.

When the image data DATA is the full white, the duty ratio controlling part 154 outputs the duty ratio control signal DCS corresponding to the first duty ratio less than about 50%, e.g., the duty ratio control signal DCS that controls the duty ratio of the driving signal DS for driving the light source in the first light emitting area of the light source module 140 corresponding to the first display area as the first duty ratio less than about 50% (S240).

The driving signal generating part 256 outputs the driving signal DS to the light source module 140 based on the duty ratio control signal DCS (S310).

When the image data is not the full white, the image analyzing part 152 determines whether the ratio of the display area is less than the first value or not (S250). In one exemplary embodiment, for example, the first value may be about 50%.

When the ratio of the first display area is less than the first value, the image analyzing part 152 determines whether the ratio of the display area is less than the second value, which is less than the first value, or not (S260). In one exemplary embodiment, for example, the second value may be about 30%.

When the ratio of the first display area is less than the second value, the duty ratio controlling part 154 outputs the duty ratio control signal DCS corresponding to the second duty ratio of about 50%, e.g., the duty ratio control signal DCS that controls the duty ratio of the driving signal DS as the second duty ratio of about 50%, and the current controlling part 254 outputs the current control signal CCS that increases the current of the driving signal DS (S270).

The driving signal generating part 256 outputs the driving signal DS to the light source module 140 based on the duty ratio control signal DCS and the current control signal CCS (S300).

When the ratio of the first display area is less than the first value and equal to or greater than the second value, the duty ratio controlling part 154 output the duty ratio control signal DCS that controls the duty ratio of the driving signal DS as the second duty ratio of about 50% (S280). The current of the driving signal DS is substantially maintained.

The driving signal generating part 256 outputs the driving signal DS to the light source module 140 based on the duty ratio control signal DCS (S310).

When the ratio of the first display area is not less than the first value, the duty ratio controlling part 154 output the duty ratio control signal DCS that controls the duty ratio of the driving signal DS as a duty ratio less than about 50% and between the first duty ratio and the second duty ratio (S290).

The driving signal generating part 256 outputs the driving signal DS to the light source module 140 based on the duty ratio control signal DCS (S310).

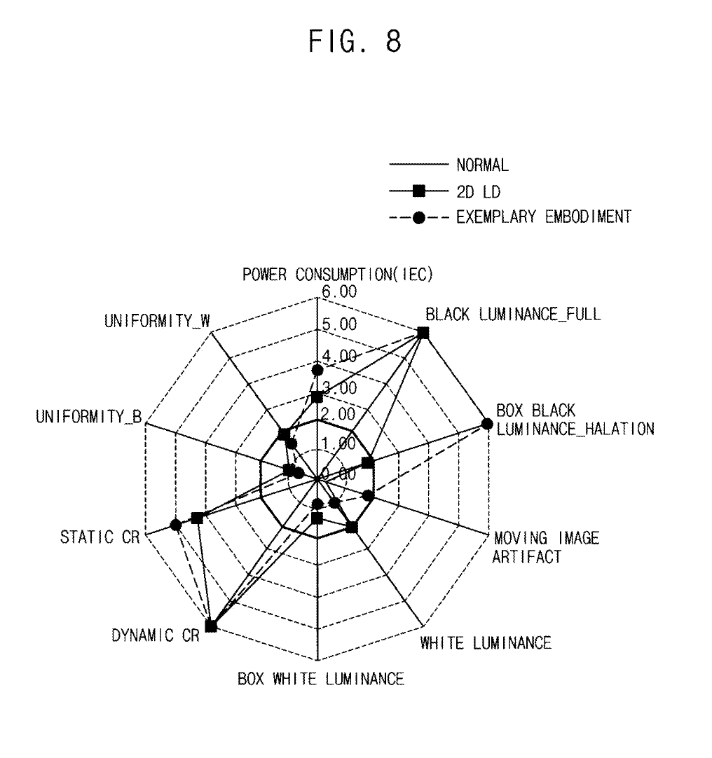

FIG. 8 is a graph illustrating power consumption (IEC) of a normal driving display apparatus (NORMAL), a local dimming driving display apparatus (2D LD) and an exemplary embodiment of the display apparatus 200 according to the invention.

The normal driving display apparatus does not use a local dimming method, such that a display panel in the normal driving display apparatus is not divided to a plurality of display blocks and a light source module in the normal driving display apparatus is not divided to a plurality of light emitting blocks.

The local dimming driving display apparatus uses a local dimming method, therefore a display panel in the local dimming driving display apparatus includes a plurality of display blocks and a light source in the local dimming driving display includes a plurality of light emitting blocks. In the local dimming driving display apparatus, each the light emitting blocks of the light source module may be driven independently of each other.

The exemplary embodiment of the display apparatus 200, as described above, includes the display panel 110 and the light source module 140, the display panel 110 includes the display blocks DB, and the light source module 140 includes the light emitting blocks LB. In such an embodiment, each of the light emitting blocks LB of the light source module 140 may be driven independently of each other. In such an embodiment, the duty ratio of the driving signal for driving the light source in the first light emitting area corresponding to the first display area is increased, as the ratio of the first display area with respect to the whole display area in the display panel 110 is decreased, and the duty ratio of the driving signal for driving the light source in the first light emitting area is decreased, as the ratio of the first display area is increased. The first display area displays the maximum luminance image.

Referring to FIG. 8, when a maximum luminance image is displayed, the exemplary embodiment of the display apparatus 200 may have relatively low power consumption compared to the normal driving display apparatus and the local dimming driving display apparatus that displays a two-dimensional plane image.

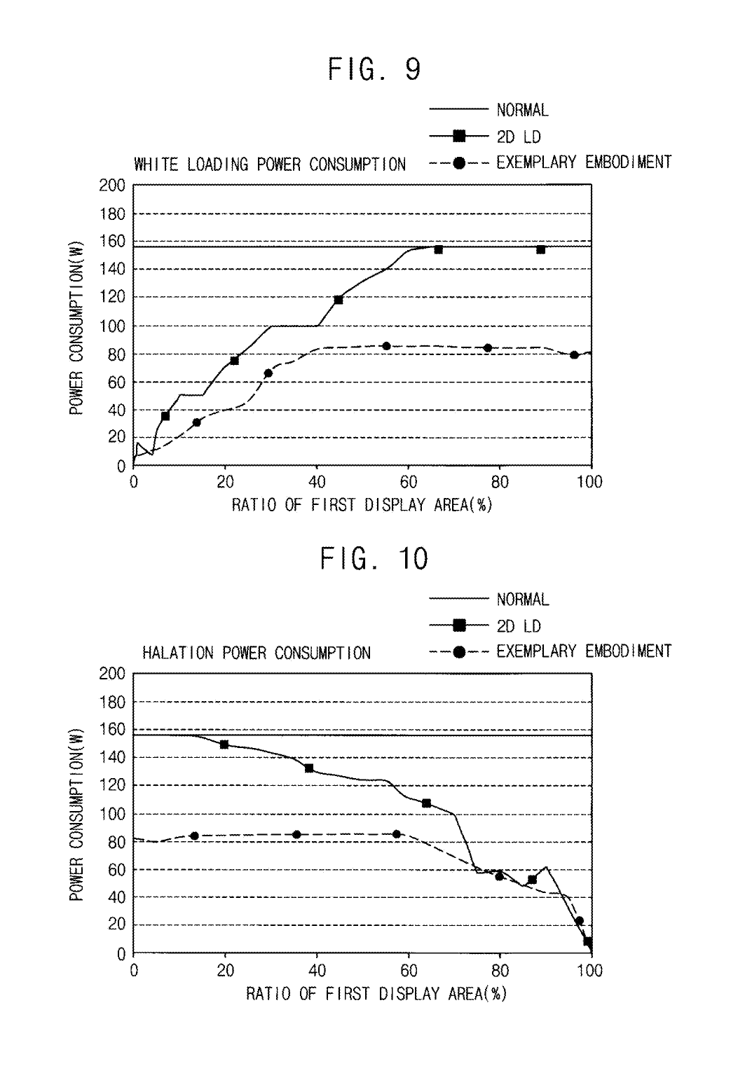

FIG. 9 is a graph illustrating power consumption (Watt: W) according to a ratio (%) of the first display area of the normal driving display apparatus, the local dimming driving display apparatus and an exemplary embodiment of the display apparatus 200.

Referring to FIG. 9, when the ratio of the first display area is equal to or greater than about 5%, the exemplary embodiment of the display apparatus 200 may have relatively low power consumption compared to the normal driving display apparatus and the local dimming driving display apparatus.

Table 1 illustrates power consumption of the normal driving display apparatus, the local dimming driving display apparatus and the exemplary embodiment of the display apparatus 200, when the display apparatuses display a moving image.

TABLE 1

| | Exemplary | | |
|---|---|---|---|
| moving image | Embodiment | 2D LD | Normal |
| Power consumption | 85.2 W | 111.6 W | 155.0 W |

Referring to Table 1, when the moving image is displayed by the display apparatuses, power consumption of the normal driving display apparatus was about 155.0 W, power consumption of the local dimming driving display apparatus was about 111.6 W, and power consumption of the exemplary embodiment of the display apparatus 200 was about 82.5 W. Thus, when the moving image is displayed by the display apparatuses, the exemplary embodiment of the display apparatus 200 may have relatively low power consumption compared to the normal driving display apparatus and the local dimming driving display apparatus.

FIG. 10 is a graph illustrating halation power consumption (W) according to the ratio (%) of the first display area of the normal driving display apparatus, the local dimming driving display apparatus and an exemplary embodiment of the display apparatus 200.

Referring to FIG. 10, when halation is displayed by the display apparatuses, the exemplary embodiment of the display apparatus 200 may have relatively low power consumption compared to the normal driving display apparatus and the local dimming driving display apparatus.

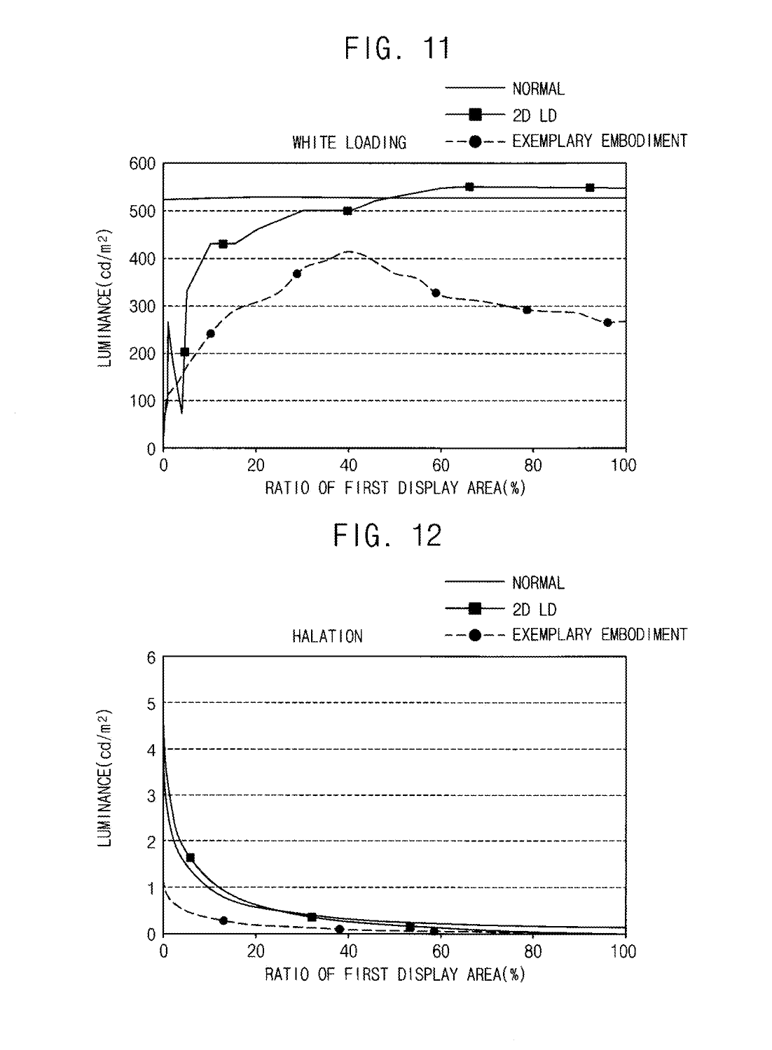

FIG. 11 is a graph illustrating a luminance (candela per square meter: cd/m²) according to the ratio of the first display area of the normal driving display apparatus, the local dimming driving display apparatus and an exemplary embodiment of the display apparatus 200.

Referring to FIG. 11, when the ratio of the first display area is equal to or greater than about 5%, the luminance of the exemplary embodiment of the display apparatus 200 was relatively low compared to the luminance of the normal driving display apparatus and the luminance of the local dimming driving display apparatus.

FIG. 12 is a graph illustrating a halation luminance (cd/m²) according to the ratio (%) of the first display area of the normal driving display apparatus, the local dimming driving display apparatus and an exemplary embodiment of the display apparatus 200.

Referring to FIG. 12, when the halation is displayed by the display apparatuses, a luminance of the exemplary embodiment of the display apparatus 200 was relatively low compared to the luminance of the normal driving display apparatus and the luminance of the local dimming driving display apparatus.

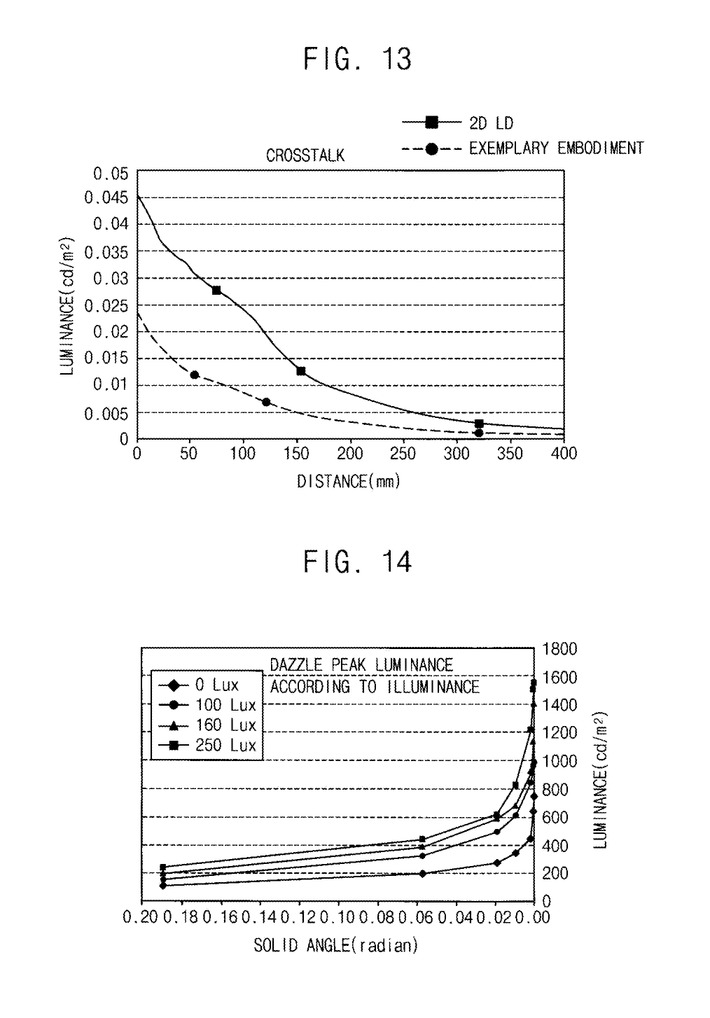

FIG. 13 is a graph illustrating a luminance (cd/m²) influencing an adjacent display block in accordance with a distance (millimeter: mm) between the display blocks of the local dimming driving display apparatus and the exemplary embodiment of the display apparatus 200.

Referring to FIG. 13, the luminance influencing the adjacent display block of the exemplary embodiment of the display apparatus 200 was low compared to the luminance influencing the adjacent display block of the local dimming driving display apparatus. Thus, the exemplary embodiment of the display apparatus 200 may have relatively low crosstalk between the display blocks compared to the local dimming driving display apparatus.

Table 2 illustrates flicker of the normal driving display apparatus, the local dimming driving display apparatus, and the exemplary embodiment of the display apparatus 200, when the display apparatuses display a moving image.

TABLE 2

| | Exemplary | | |
|---|---|---|---|
| moving image | Embodiment | 2D LD | Normal |
| flicker | 1.5 | 8.9 | 0.2 |

Referring to Table 2, the flicker of the exemplary embodiment of the display apparatus 200 was ⅙ compared to the flicker of the local dimming driving display apparatus. Thus, the exemplary embodiment of the display apparatus 200 may have relatively low flicker compared to the local dimming driving display apparatus.

FIG. 14 is a graph illustrating a relation between a solid angle (radian) and a dazzle peak luminance (cd/m²) according to illuminance (lux).

Here, the solid angle may be an angle between an eye of the viewer and an upper edge of the first display area.

Referring to FIG. 14, the dazzle peak luminance was increased, as the illuminance was increased. Increasing shape of the dazzle peak luminance according to a size of the first display area was similar, when the illuminance was changed.

The dazzle peak luminance, the solid angle and the first display area satisfies the following Equation 1.

L ∝ ω^{-0.25} ∝ A^{-0.25} Equation 1

In Equation 1, ‘L’ denotes dazzle peak luminance (cd/m²), ‘w’ denotes solid angle (radian), and ‘A’ denotes size of the first display area (square meter (m²)).

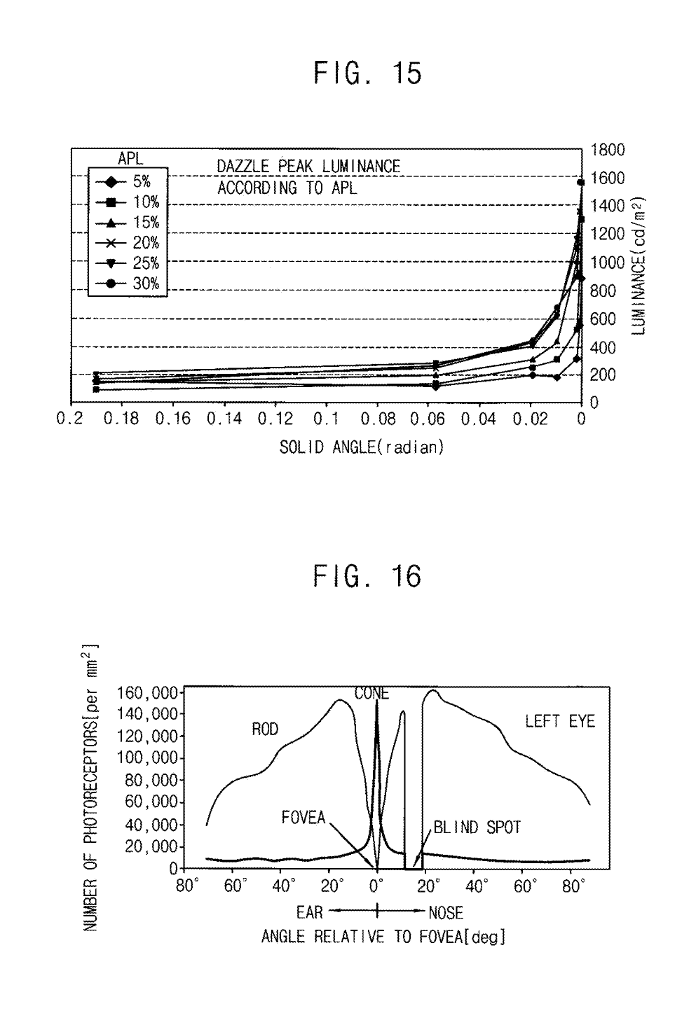

FIG. 15 is a graph illustrating a relation between the solid angle (radian) and a dazzle peak luminance (cd/m²) according to an average picture level (“APL”), and FIG. 16 is a graph illustrating a cone photoreceptors distribution of an eye.

Referring to FIGS. 15 and 16, the dazzle peak luminance was sharply increased, as the solid angle was decreased. In addition, an eye of the viewer substantially sensitively responded to a light in a sight range equal to or less than about 10 degrees. Thus, the dazzle peak luminance is sharply increased, as the size of the first display area is decreased.

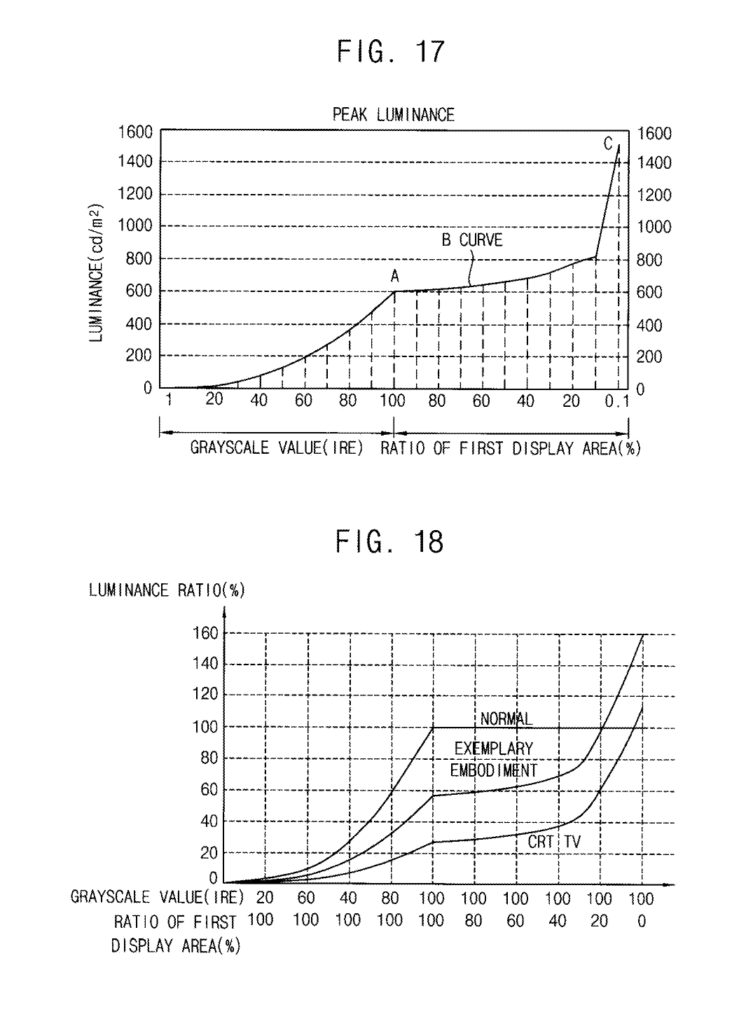

FIG. 17 is a graph illustrating the dazzle peak luminance (cd/m²) according to a grayscale value (IRE) and the ratio (%) of the first display area.

Referring to FIG. 17, when the ratio of the first display area is maximum, i.e., a portion ‘A’ in the graph, the dazzle peak luminance was about 600 cd/m². A curve ‘B’ indicates the dazzle peak luminance according to the ratio of the first display area, and the curve ‘B’ may be represented by Equation 2.

Lum=1/\sqrt{A} Equation 2

In Equation 2, Lum denotes dazzle peak luminance (cd/m²), and ‘A’ denotes size of first display area (m²).

When the ratio of the first display area is minimum, i.e., a portion ‘C’ in the graph, the dazzle peak luminance was about 1500 cd/m².

FIG. 18 is a graph illustrating a luminance ratio (%) according to a grayscale value (IRE) and the ratio (%) of the first display area of cathode ray tube (“CRT”) display apparatus, the normal driving display apparatus and an exemplary embodiment of the display apparatus 200.

Referring to FIG. 18, when the ratio of the first display area was about 100%, the luminance of the exemplary embodiment of the display apparatus 200 was relatively low compared to the luminance of the normal driving display apparatus. In FIG. 18, the luminance of the normal driving display apparatus was substantially constant, while the luminance of the exemplary embodiment of the display apparatus 200 was increased, as the ratio of the first display area was decreased.

According to exemplary embodiments of the method of driving the light source, the light source apparatus for performing the method and the display apparatus having the light source apparatus, crosstalk of a three-dimensional stereoscopic image is effectively prevented, and thus display quality of the display apparatus is substantially improved.

In such embodiments, a current of a driving signal may be controlled based on a ratio of a first display area, which displays a maximum luminance image, and a ratio of a second display area, which displays a minimum luminance image, and thus power consumption of the display apparatus is substantially decreased.

The foregoing is illustrative of the invention and is not to be construed as limiting thereof. Although a few exemplary embodiments of the invention have been described, those skilled in the art will readily appreciate that many modifications are possible in the exemplary embodiments without materially departing from the novel teachings and advantages of the invention. Accordingly, all such modifications are intended to be included within the scope of the invention as defined in the claims. In the claims, means-plus-function clauses are intended to cover the structures described herein as performing the recited function and not only structural equivalents but also equivalent structures. Therefore, it is to be understood that the foregoing is illustrative of the invention and is not to be construed as limited to the specific exemplary embodiments disclosed, and that modifications to the disclosed exemplary embodiments, as well as other exemplary embodiments, are intended to be included within the scope of the appended claims. The invention is defined by the following claims, with equivalents of the claims to be included therein.

What is claimed is:

1. A method of driving a light source, the method comprising:
determining a ratio of a first display area with respect to an entire display area by analyzing an image data, wherein the first display area displays a maximum luminance image;
generating a duty ratio control signal which controls a duty ratio of a driving signal based on the ratio of the first display area, wherein the driving signal drives a light source in a first light emitting area of a light source module, and the first light emitting area corresponds to the first display area; and
outputting the driving signal to the light source module based on the duty ratio control signal.

2. The method of claim 1, wherein
the duty ratio of the driving signal is increased as the ratio of the first display area decreases, and
the duty ratio of the driving signal is decreased as the ratio of the first display area increases.

3. The method of claim 1, wherein the duty ratio of the driving signal which drives the light source in the first light emitting area is a first ratio.

4. The method of claim 3, wherein the first ratio is equal to or less than about 50%.

5. The method of claim 4, wherein
the driving signal which drives the light source in the first light emitting area is inactivated during an initial period of a frame, and
the light source in the first light emitting area is turned off during the initial period of the frame based on the driving signal.

6. The method of claim 1, wherein the determining the ratio of the first display area comprises:
determining whether the ratio of the first display area is about 100% or not;
determining whether the ratio of the first display area is less than 100% and equal to or greater than a first value, which is less than about 100%, or not; and
determining whether the ratio of the first display area is less than the first value or not.

7. The method of claim 6, wherein the duty ratio of the driving signal is less than about 50%, when the ratio of the first display area is equal to or greater than the first value.

8. The method of claim 6, wherein the duty ratio of the driving signal is about 50%, when the ratio of the first display area is less than the first value.

9. The method of claim 6, wherein the determining the ratio of the first display area further comprises:
determining whether the ratio of the first display area is less than a second value, which is less than the first value or not; and
determining whether the ratio of the first display area is less than the first value and equal to or greater than the second value or not.

10. The method of claim 9, further comprising:
outputting a current control signal which maintains a current of the driving signal when the ratio of the first display area is equal to or greater than the second value; and
outputting the current control signal which increases the current of the driving signal when the ratio of the first display area is less than the second value.

11. The method of claim 1, further comprising:
analyzing the image data to determine a second display area which displays a minimum luminance image.

12. The method of claim 11, wherein
a duty ratio of a driving signal, which drives a light source in a second light emitting area of the light source module, is about zero (0), wherein the second light emitting area corresponds to the second display area.

13. A light source apparatus comprising:
a light source module comprising a plurality of light sources; and
a light source driving part configured to determine a ratio of a first display area with respect to an entire display area by analyzing an image data, configured to generate a duty ratio control signal, which controls a duty ratio of a driving signal based on the ratio of the first display area, and configured to output the driving signal, which drives a light source of the light sources corresponding to the first display area, to the light source module,
wherein the first display area displays a maximum luminance image.

14. The light source apparatus of claim 13, wherein
the duty ratio of the driving signal increases as the ratio of the first display area becomes low, and
the duty ratio of the driving signal decreased as the ratio of the first display area becomes high.

15. The light source apparatus of claim 13, wherein the light source driving part comprises:
an image analyzing part configured to analyze the image data to determine the ratio of the first display area;
a duty ratio controlling part configured to generate the duty ratio control signal of the driving signal based on the ratio of the first display area; and
a driving signal generating part configured to output the driving signal to the light source module based on the duty ratio control signal.

16. The light source apparatus of claim 15, wherein
the image analyzing part determines whether the ratio of the first display area is about 100% or not,
the image analyzing part determines whether the ratio of the first display area is less than about 100% and equal to or greater than a first value, which is less than about 100%, or not, and
the image analyzing part determines whether the ratio of the first display area is less than the first value or not.

17. The light source apparatus of claim 16, wherein
the duty ratio of the driving signal is less than about 50%, when the ratio of the first display area is equal to or greater than the first value, and
the duty ratio of the driving signal is about 50%, when the ratio of the first display area is less than the first value.

18. The light source apparatus of claim 16, wherein
the image analyzing part determines whether the ratio of the first display area is less than a second value, which is less than the first value, or not, and
the image analyzing part determines whether the ratio of the first display area is less than the first value and equal to or greater than the second value or not.

19. The light source apparatus of claim 18, wherein
the light source driving part further comprises a current controlling part configured to maintain a current of the driving signal when the ratio of the first display area is equal to or greater than the second value and configured to increase the current of the driving signal when the ratio of the first display area is less than the second value.

20. A display apparatus comprising:
a display panel displaying an image corresponding to an image data;
a light source module disposed facing an edge portion of the display panel, wherein the light source module provides light to the display panel and comprises a plurality of light sources; and
a light source driving part configured to determine a ratio of a first display area with respect to an entire display area by analyzing the image data, configured to generate a duty ratio control signal which controls a duty ratio of a driving signal based on the ratio of the first display area, and configured to output the driving signal to the light source module based on the duty ratio control signal,
wherein the first display area displays a maximum luminance image,
wherein the duty ratio control signal increases the duty ratio of the driving signal as the ratio of the first display areas decreases and decreases the duty ratio of the driving signal as the ratio of the first display area increases, and
wherein the driving signal drives a light source in a first light emitting area of the light source module corresponding to the first display area.
